(19) United States
(12) Patent Application Publication
(10) Pub. No.: US 2007/0227512 A1
(43) Pub. Date: Oct. 4, 2007

(54) Solenoid Valve

(75) Inventor: Robert J. Steinman, Lexington, OH (US)

Correspondence Address: GROSSMAN, TUCKER, PERREAULT & PFLEGER, PLLC, 55 SOUTH COMMERICAL STREET, MANCHESTER, NH, 03101, US

(73) Assignee: STONERIDGE, INC., Warren, OH (US)

(21) Appl. No.: 11/670,772

(22) Filed: Feb. 2, 2007

Related U.S. Application Data
(60) Provisional application No. 60/764,885, filed on Feb. 3, 2006.

(51) Int. Cl. F02M 33/02; F16K 31/02; H01F 7/06

(52) U.S. Cl. 123/519; 251/129.15; 29/592.1

(57) ABSTRACT

A solenoid valve 10 is provided generally including a bobbin 12 for supporting a coil 14 and a core 16 located adjacent to the bobbin 12. An armature 18 is movably disposed relative to the core 16. A plunger 24 is coupled to the armature 18 and movable with the armature 18. A seal 26 is coupled to the plunger 24, with the seal 26 movable between an open position and a closed position sealingly engaged with a valve seat 28. The solenoid valve 10 further includes a damper 40 which includes a foam material between a valve seal 26 and a portion of a plunger flange 38. The damper 40 may damp, or cushion, any impact between the valve seal 26 and the valve seat 28.

### CROSS REFERENCE TO RELATED APPLICATIONS

This application claims the benefit of U.S. Provisional Application No. 60/764,885, filed Feb. 3, 2006, the teachings of which are fully incorporated herein by reference.

### FIELD

The present disclosure relates to solenoids, and more particularly to solenoid valves.

### BACKGROUND

Solenoids are used in a myriad of applications in the automotive industry. For example, solenoids may be used in automated or remote valves, such as a canister vent solenoid associated with evaporative emission control systems. Such solenoid valves may be used to control the flow of a variety of fluids or gasses. For example, in the context of a canister vent solenoid, the solenoid valve may be used to control the flow of fuel vapors into a charcoal canister. Solenoid valves may be similarly used to control the flow of liquids and vapors for other vehicle systems.

During operation, the solenoid armature may move a seal on a plunger to engage and disengage a valve seat. Generally, when the seal is engaged with the valve seat the solenoid valve is in a closed condition, and when the seal is disengaged from the valve seat the solenoid valve is in an opened condition. The opening and closing of the solenoid valve may create various audible noises. For example, when the valve is moved to a closed position, the seal may slap against the valve seat. The audible noises associated with the various mechanical components of a motor vehicle are often considered undesirable, and the elimination of such audible noises may generally be considered to be beneficial.

### BRIEF DESCRIPTION OF THE DRAWINGS

Features and advantages of solenoids consistent with the present disclosure will be apparent from the following description of embodiments consistent therewith, wherein:

FIG. 1 is a cross-sectional view of an embodiment of a solenoid valve consistent with the present disclosure in an opened configuration;

FIG. 2 is a cross-sectional view of an embodiment of a solenoid valve consistent with the present disclosure in a closed configuration; and

FIG. 3 is a schematic view of one embodiment of the solenoid valve consistent with the present disclosure in combination with a fuel and evaporative emission control system.

### DESCRIPTION

In general, the present disclosure may provide a solenoid valve having reduced audible operating noise. Particularly, a solenoid consistent with the present disclosure may include damping features configured to reduce audible noise associated with moving components of the solenoid impacting against other components during the operation of the solenoid. For example, damping features may be provided to reduce the audible noise associated with a valve seal striking a valve seat during closing of the valve. Similarly, damping features may be provided to reduce the audible noise associated with impact between other components of a solenoid, for example, the noise associated with an armature striking an upper bobbin portion or a stop during opening of the valve, etc. While the description herein is set forth in the context of a solenoid valve, such as a canister vent solenoid, the damping features consistent with the present disclosure are susceptible to application in solenoid mechanisms and systems in general, and should not be limited to solenoid valves.

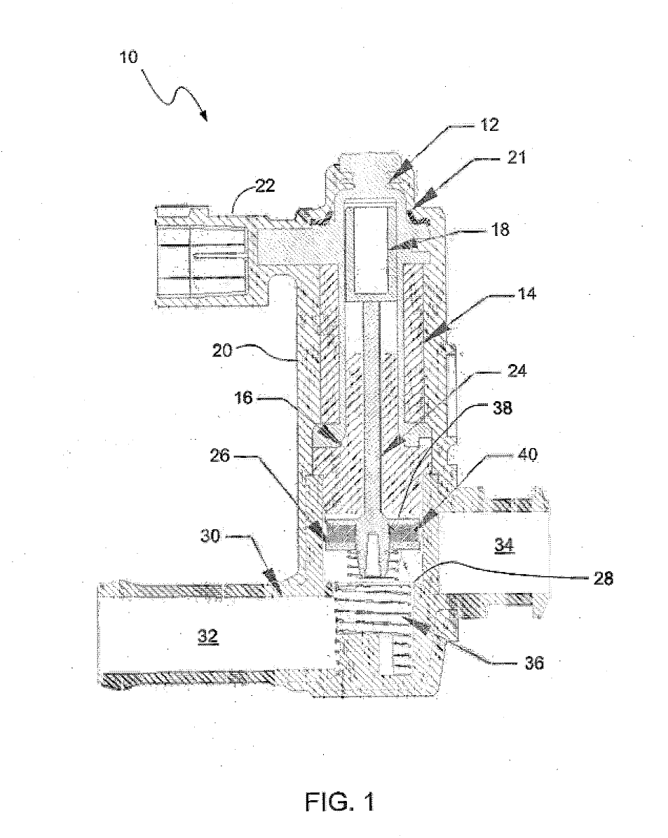

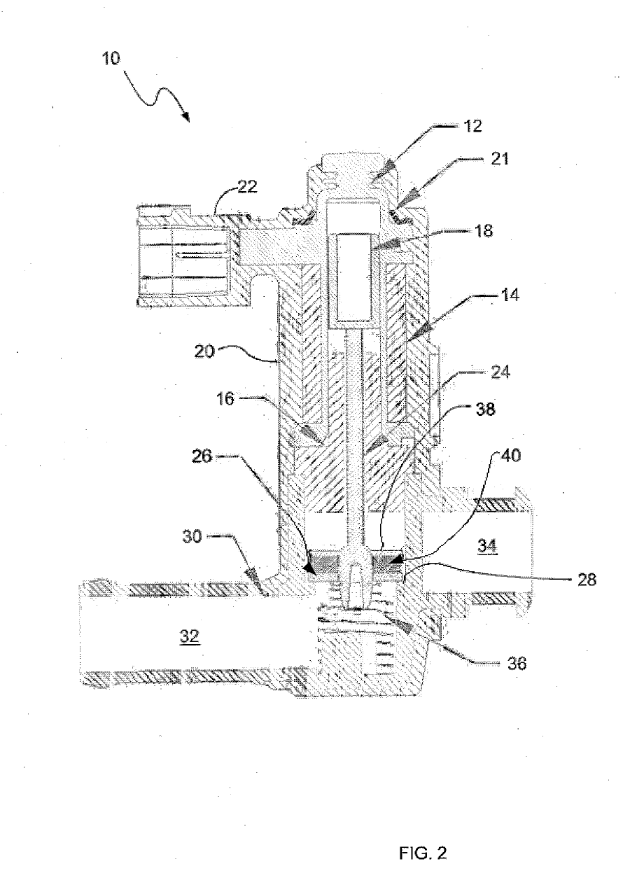

Referring to the drawings, FIGS. 1 and 2 illustrate a cross-sectional view of an embodiment of a solenoid 10 consistent with the present disclosure in an open and closed position, respectively. The solenoid 10 may include a bobbin 12, which may support a solenoid coil 14. A solenoid core 16 may be disposed adjacent the bobbin 12. For example, the core 16 may be disposed extending at least partially within the bobbin 12. Correspondingly, the core 16 may be disposed adjacent to the coil 14, which may be supported by the bobbin 12. As such, the core 16 may also extend at least partially within the coil 14. Other arrangements of the bobbin 12, coil 14, and the core 16 may also suitably be employed.

The solenoid 10 may also include an armature 18, which may be moveably disposed relative to the core 16. As in the illustrated embodiment, the armature 18 may be slidably disposed at least partially within the bobbin 12. For example, the armature 18 may be slidably disposed along the axis of the bobbin 12. At least a portion of the bobbin 12 may be disposed in a solenoid housing 20. The bobbin 12, and thereby the coil 14, core 16, etc., may be retained in the housing 20 by a retaining bracket 21. As shown, the solenoid housing 20 may include a connector 22 for providing power to the coil 14, etc. As shown, the connector 22 may be provided as an integral feature of the solenoid housing 20. In other embodiments, power to the coil 14 may be provided through hardwired electrical connection, pigtail connectors, etc.

The armature 18 may be coupled to a plunger 24 to permit the armature 18 and the plunger 24 to move together in at least one direction. However, movement of the armature 18 and the plunger 24 does not require the armature 18 and the plunger 24 to be physically joined or directly coupled, although such an arrangement may suitably be employed. A valve seal 26 may be disposed adjacent to one end of the plunger 24 and may be movable relative to a valve seat 28. Movement of the valve seal 26 to sealingly engage the valve seat 28 (as shown in FIG. 2) may close the valve to fluid communication between associated passages 32, 34. Correspondingly, movement of the valve seal 26 out of sealing engagement with the valve seat 28 may open the valve (as shown in FIG. 1) for fluid communication between the associated passages 32, 34. Accordingly, the valve seal 26 may be movably coupled to the armature 18 through the plunger 24. The valve seal 26 may be constructed from a generally metallic material such as, but not limited to, steel, brass, iron, or the like. The valve seal 26 may also be constructed from a plastic material or the like.

The valve seat 28 may be provided by a valve body 30, which may be coupled to the solenoid housing 20, or otherwise associated with the plunger 24. As shown, at least a portion of the valve seal 26 and the plunger 24 may be at least partially disposed within the valve body 30, at least when the valve is in a closed condition as shown in FIG. 2. A return spring 36 may bias the valve seal 26 toward an open position as shown in FIG. 1. For example, the return spring 36 may be at least partially disposed within the valve body 30 and may bear against the valve seal 26, or directly on the plunger 24.

When the coil 14 is not energized, the return spring 36 may bias the valve seal 26, plunger 24, and the armature 18 toward a first position, i.e., and open position shown in FIG. 1, in which the armature 18, plunger 24, and valve seal 26 are positioned toward the end of the bobbin 12 away from the valve seat 28. When the coil 14 is energized, the magnetic field induced in the core 14 may urge the armature 18, and the plunger 24 against the bias of the return spring 36 and toward a second, closed, position shown in FIG. 2 in which the plunger 24 and armature 18 are positioned toward the valve seat 28, by comparison to the first position. The valve seal 26 may be urged into sealing engagement with the valve seat 28 in the second position.

The plunger 24 may be coupled to the valve seal 26 via a flange 38 or similar feature. The flange 38 may transmit force between the plunger 24 and the valve seal 26. For example, when the coil 14 is energized, the armature 18 may apply a force on the plunger 24 toward the valve seat 28. The plunger 24 may transmit at least a portion of the force to the valve seal 26 through the flange 38, thereby enabling the plunger 24 to move the valve seal 26 into sealing engagement with the valve seat 28. Similarly, in one embodiment, the return spring 36 may apply a return force on the valve seal 26. The valve seal 26 may transmit at least a portion of the return force to the plunger 24 through the flange 38.

When the valve seal 26 is driven into sealing engagement with the valve seat 28 by the plunger 24, vibrational energy and audible noise may be generated by the impact of the valve seal 26 against the valve seat 28. The vibrational energy generated by the impact may be transmitted to the plunger 24 and to other components of the valve, solenoid, mounting hardware, etc. According to one aspect, the plunger 24 and flange 38 may be coupled to the valve seal 26 via a damping feature or seal vibration damper 40. The damping feature 40 may reduce, mitigate, or diminish, the transmission of the vibration energy generated by the impact from the valve seal 26 to the plunger 24, e.g., via the flange 38. The reduction of vibration energy transmitted to the plunger 24, as well as to other components of valve and solenoid, may reduce or eliminate audible noise associated with the closing of the valve.

The damping feature 40 may be disposed between the flange 38 and the valve seal 26 and may couple the valve seal 26 and the plunger 24. In one embodiment, the damping feature 40 may be provided as an annular feature which may be disposed around the plunger 24 and at least partially between the flange 38 and the valve seal 26. As shown, the damping feature 40 may have a diameter generally corresponding to the diameter of the flange 38 and of the valve seal 26. In other embodiments, the damping feature 40 may include a discontinuous contact between the flange 38 and the valve seal 26. For example, the damping feature 40 may be provided as a plurality of discrete members, such as annulus segments, etc.

The damping feature 40 may be free-floating, or may be fixed to one or both of the flange 38 and the valve seal 26. For example, the damping feature 40 may be adhesively bonded, mechanically fastened, staked, etc., to one or both of the valve seal 26 and the flange 38. Similarly, the damping feature 40 may be fixed to the plunger 24, e.g., via frictional engagement, adhesive bonding, etc.

In one embodiment, the damping feature 40 may include an elastomeric member. For example, the damping feature 40 may be a cellular polymeric foam member. The foam member may be a resilient foam, such as a thermoplastic elastomeric foam, or a thermoset foam, such as a polyurethane foam, etc. In other embodiments, the foam member may be a rigid foam of either a thermoplastic or a thermoset material. Additionally, the use of both closed cell and open cell foam members are contemplated for use in connection with a damping feature 40 consistent with the present disclosure. In addition to reducing the transmission of vibration energy from the valve seal 26 to the plunger 24 and other components, a foam damping feature herein may have relatively little negative impact on the movement of the plunger 24. Similarly, the damping feature 40 may result in relatively little, or no, reduction in the sealing force between the valve seal 26 and the valve seat 28.

According to another aspect, a second damping feature may be provided between at least one of the plunger and the armature or the armature and the bobbin as described in U.S. Pat. No. 7,259,840, which is fully incorporated herein by reference. In such an arrangement, the second damping feature may reduce or eliminate the transmission of vibration energy which may be generated by to return of the plunger and armature to the open position, i.e., in which the plunger and armature are positioned away from the valve seat. Consistent with this aspect, the second damping feature may be a foam material, similar to the previously described damping feature. As such, the second damping feature may be an open or closed cell foam and may include a rigid or resilient polymeric material.

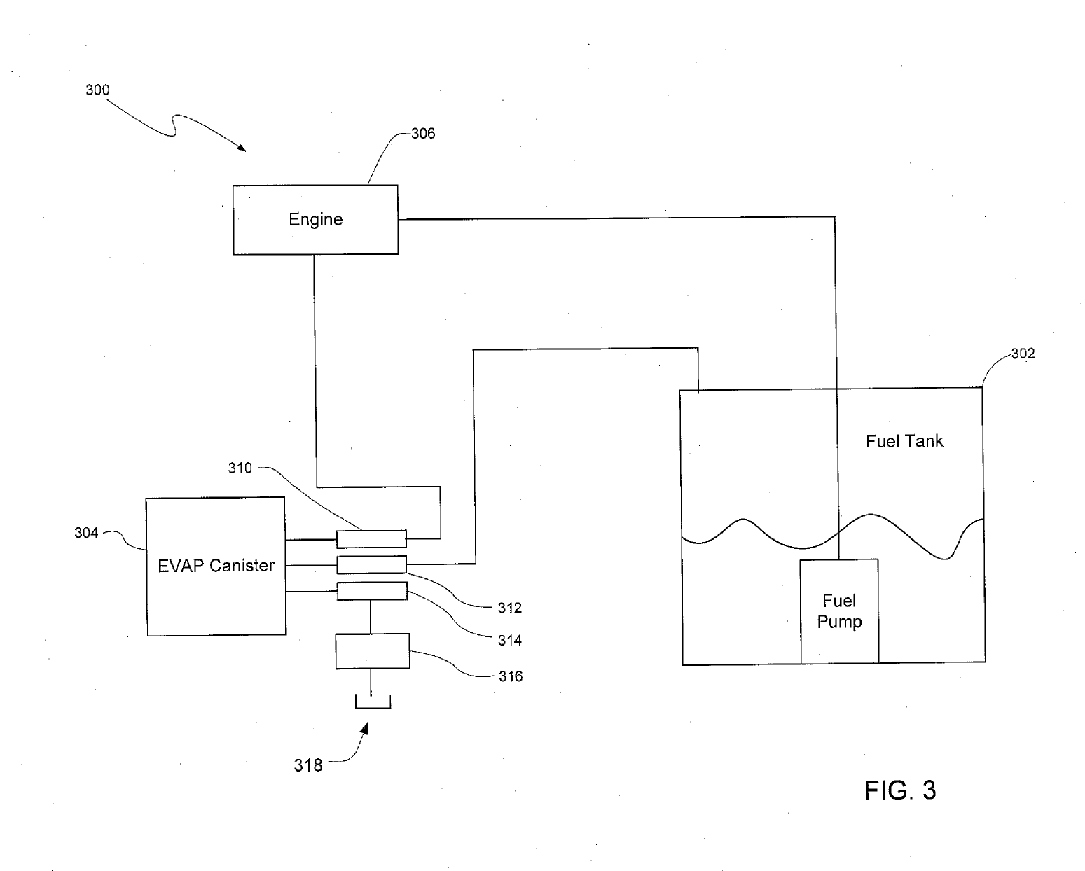

Referring now to FIG. 3, an evaporative emission control system 300 consistent with the present disclosure is schematically illustrated. The evaporative emissions system 300 may control the release of fuel vapors from a fuel tank 302 during refueling, during elevated temperatures, or the like, in which fuel vapors from the fuel tank 302 may be displaced from, e.g. due to being pressurized within, the fuel tank 302 by liquid fuel being delivered to the fuel tank 302. For example, fuel vapors from the fuel tank 302 may travel to an evaporative emissions canister 304, which may serve as a storage device for fuel vapors. The evaporative emissions canister 304 may contain a medium, such as activated carbon, which may collect the fuel vapors to prevent the vapor from being emitted into the atmosphere. During normal operation of the vehicle, the fuel vapors collected by the evaporative emissions canister 304 may be released and consumed by the engine 306.

The evaporative emissions system 300 may also include a plurality of valves 310, 312, 314 wherein at least one of the valves 310, 312, 314 may be consistent with the solenoid valve 10 described above. For example, the evaporative emissions system 300 may include a canister purge valve 310, a vapor blocking valve 312, and a canister vent valve 314. The canister purge valve 310 may be disposed between the engine 306 and the evaporation canister 304 for controlling the flow of air and/or fuel vapor from the evaporation canister 304 to the engine 306. The vapor blocking valve 312 may be disposed between fuel tank 302 and the evaporation canister 304 for controlling the flow of air and/or fuel from the fuel tank 302 to the evaporation canister 304. The canister vent valve 314 may be disposed between the evaporation canister 304 and an air filter 316 for controlling the flow of air between the air filter 316 and the evaporation canister 304. The air filter 316 may remove any particulate or liquid (e.g., moisture, contaminates, or the like) from an air intake provided by an atmospheric vent 318. While three valves 310, 312, 314 are shown, the evaporative emissions system 300 may include a greater or fewer number of valves.

An engine control module or similar control system (not shown) may transmit a signal to the valves 310, 312, 314 resulting in the opening and/or closing of the valves 310, 312, 314. In response to the signals from the engine control module, the valves 310, 312, 314 may be fully opened/closed or partially opened/closed. According to one embodiment, one or more of the valves 310, 312, 314 may be normally open (i.e., the valve 310, 312, 314 may be in an open position unless otherwise instructed to close). In this case, the valve 310, 312, 314 may be open unless instructed to close. For example, the valve 310, 312, 314 may be fail-safe open. According to another embodiment, one or more of the valves 310, 312, 314 may be normally closed (i.e., the valve 310, 312, 314 may be in a closed position unless otherwise instructed to open). In this case, the valve 310, 312, 314 may be closed unless instructed to open. For example, the valve 310, 312, 314 may be fail-safe closed. Alternatively, one or more of the valves 310, 312, 314 may not be biased towards either the open or closed position.

In summary, according to one aspect, the present disclosure may provide a solenoid valve including a bobbin configured to support a coil and a core disposed adjacent to the bobbin. An armature may be moveable disposed relative to the core and a plunger may be coupled to the armature such that the plunger may be movable with the armature in at least one direction. A seal may be coupled to the plunger, and the seal may be movable between a first position away from a valve seat and a second position sealingly engaged with the valve seat when the solenoid is in an energized condition. The seal may be coupled to the plunger via a damping feature, including a foam member.

According to another aspect, the present disclosure may provide a solenoid valve including a coil and an armature movably disposed relative to the coil. A plunger may be coupled to and moveable with the armature. A seal may be movable between at least a first position away from a valve seat and a second position sealingly engaged with the valve seat when the solenoid valve is in an energized condition. At least a portion of the seal may be coupled to the plunger through a seal vibration damper.

According to yet another aspect, the present disclosure may provide an evaporative emission control system including a fuel tank, an evaporative canister, an engine, and at least one solenoid valve configured to be coupled to at least one of the fuel tank, the evaporative canister, and the engine. The solenoid valve may include a coil, an armature movably disposed relative to the coil, a plunger coupled to and movable with the armature, and a seal movable between at least a first position away from a valve seat and a second position sealingly engaged with the valve seat when the solenoid is in an energized condition. At least a portion of the seal may be coupled to the plunger through a seal vibration damper.

Additionally, the present disclosure may provide a method for reducing an audible noise associated with the operation of a solenoid. The method may include providing a solenoid valve including a bobbin, a core disposed adjacent to the bobbin, and an armature movable with respect to the core. A plunger may be provided coupled to the armature and movable with the armature in at least one direction. A valve seal may be coupled to the plunger via a damping feature including a foam member. The method of reducing an audible noise may further include energizing the solenoid and moving the seal toward a valve seat. Still further, the method may include engaging the damping feature between at least a portion of the plunger and the valve seal.

According to a further aspect, a method is provided for fabricating a solenoid valve. The method may include coupling a coil to a solenoid housing, inserting an armature within at least a portion the coil, coupling a proximate end of a plunger to the armature, and coupling a seal to a distal end of the plunger via a seal vibration damper. The seal vibration damper may reduce a transmission of vibrational energy generated by an impact between the seal and a valve seat.

According to another aspect, a method is provided for reducing audible noise associate with the operation of a solenoid valve. The method may include providing a solenoid valve comprising a coil, an armature movably disposed relative to the coil, a plunger coupled to and moveable with the armature, and a seal coupled to the plunger by a seal vibration damper. The solenoid valve may be energized to move the seal toward a valve seat and to sealingly engage with the valve seat. The transmission of vibrational energy generated by an impact between the seal and the valve seat may be reduced by absorbing at least a portion of the vibrational energy with the seal vibration damper.

According to yet another aspect, a solenoid is provided including a plunger having a flange, with the plunger being movable between a first position and a second position. The solenoid may further include a damping feature including a foam member. At least a portion of the foam member may be engaged between at least a portion of the flange and at least a portion of a valve seal when the plunger is in the second position.

The features and aspects described with reference to particular embodiments disclosed herein may be susceptible to combination and/or application in various other embodiments described herein. Such combinations and/or applications of such described features and aspects to such other embodiments are contemplated herein. Additionally, the embodiments disclosed herein are susceptible to numerous variations and modifications without materially departing from the spirit of the disclosed subject matter. Accordingly, the present disclosure should not be considered to be limited to the particular embodiments disclosed herein.

What is claimed is:

1. A solenoid valve comprising:
a coil;
an armature movably disposed relative to said coil;
a plunger coupled to and movable with said armature; and
a seal coupled to at least a portion of said plunger through a seal vibration damper, said seal movable between at least a first position away from a valve seat and a second position sealingly engaged with said valve seat when said solenoid is in an energized condition.

2. The solenoid valve of claim 1 wherein at least a portion of said seal vibration damper is disposed between said seal and a flange extending generally radially outwardly from said plunger.

3. The solenoid valve of claim 2 wherein said seal vibration damper is secured to said flange.

4. The solenoid valve of claim 3 wherein said seal vibration damper comprises a generally annular shape.

5. The solenoid valve of claim 4 wherein said seal vibration damper includes a diameter substantially corresponding to a diameter of said flange.

6. The solenoid valve of claim 3 wherein said seal vibration damper comprises a plurality of annulus segments.

7. The solenoid valve of claim 2 further comprising a bobbin configured to support said coil and a core disposed substantially adjacent to said bobbin.

8. The solenoid valve of claim 1 wherein said seal vibration damper comprises an elastomeric member.

9. The solenoid valve of claim 8 wherein said seal vibration damper comprises a resilient foam.

10. The solenoid valve of claim 9 wherein said seal vibration damper comprises a cellular polymeric foam.

11. The solenoid valve of claim 9 wherein said seal vibration damper comprises a closed cell foam.

12. The solenoid valve of claim 9 wherein said seal vibration damper comprises an open cell foam.

13. An evaporative emission control system comprising:
a fuel tank;
an evaporative canister;
an engine; and
at least one solenoid valve configured to be coupled to at least one of said fuel tank, said evaporative canister, and said engine, said at least one solenoid valve comprising:
a coil;
an armature movably disposed relative to said coil;
a plunger coupled to and movable with said armature; and
a seal coupled to at least a portion of said plunger through a seal vibration damper, said seal movable between at least a first position away from a valve seat and a second position sealingly engaged with said valve seat when said solenoid is in an energized condition.

14. The evaporative emission system of claim 13 wherein at least a portion of said seal vibration damper is disposed between said seal and a flange extending generally radially outwardly from said plunger.

15. The evaporative emission system of claim 14 wherein at least a portion of said seal vibration damper is secured to said flange.

16. The evaporative emission system of claim 15 wherein said evaporative emission system comprises a first solenoid valve disposed between an atmospheric vent and said evaporation canister, a second solenoid valve disposed between said fuel tank and said evaporation canister, and a third solenoid valve disposed between said engine and said evaporation canister, wherein each of said first, said second, and said third solenoid valves comprise:
a coil;
an armature movably disposed relative to said coil;
a plunger coupled to and movable with said armature; and
a seal coupled to at least a portion of said plunger through a seal vibration damper, said seal movable between at least a first position away from a valve seat and a second position sealingly engaged with said valve seat when said solenoid is in an energized condition.

17. The evaporative emission system of claim 16 wherein each of said first, said second, and said third solenoid valves further comprise a bobbin configured to support said coil and a core disposed substantially adjacent to said bobbin.

18. The evaporative emission system of claim 17 wherein at least one of said seal vibration dampers comprises a closed cell foam.

19. The evaporative emission system of claim 17 wherein at least one of said seal vibration dampers comprises an open cell foam.

20. A method of fabricating a solenoid valve comprising:
coupling a coil to a solenoid housing;
inserting an armature within at least a portion said coil;
coupling a proximate end of a plunger to said armature; and
coupling at least a portion of a seal to a distal end of said plunger through a seal vibration damper, wherein said seal vibration damper reduces a transmission of vibrational energy generated by an impact between said seal and a valve seat.
